(19) United States
(12) Patent Application Publication
(10) Pub. No.: US 2024/0221989 A1
(43) Pub. Date: Jul. 4, 2024

(54) COIL COMPONENT

(71) Applicant: SAMSUNG ELECTRO-MECHANICS CO., LTD., Suwon-si (KR)

(72) Inventors: Byeong Cheol MOON, Suwon-si (KR); Han LEE, Suwon-si (KR); Sang Jin KIM, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/387,792

(22) Filed: Nov. 7, 2023

(30) Foreign Application Priority Data
Jan. 3, 2023 (KR) 10-2023-0000838
Mar. 24, 2023 (KR) 10-2023-0038486

(51) Int. Cl. H01F 27/00; H01F 27/28; H01F 27/29

(52) U.S. Cl. CPC H01F 27/006; H01F 27/2823; H01F 27/29

(57) ABSTRACT

A coil component includes a body, a first coil and a second coil disposed within the body to be spaced apart from each other in a first direction, parallel to a central axis, a first conductive via connecting the first and second coils to each other, a third coil and a fourth coil disposed within the body to be spaced apart from each other in the first direction, a second conductive via connecting the third and fourth coils to each other, a first additional pattern connected to the first coil by a first additional via, first and second external electrodes disposed on the body and respectively connected to the first and second coils, and third and fourth external electrodes disposed on the body and respectively connected to the third and fourth coils.

### CROSS-REFERENCE TO RELATED APPLICATION (S)

This application claims benefit of priority to Korean Patent Application Nos. 10-2023-0000838 filed on Jan. 3, 2023 and 10-2023-0038486 filed on Mar. 24, 2023 in the Korean Intellectual Property Office, the disclosures of which are incorporated herein by reference in the entirety.

### TECHNICAL FIELD

The present disclosure relates to a coil component.

With a reduction in size and thickness of electronic devices such as digital TVs, mobile phones, laptops, and the like, it has been required for coil components applied to the electronic to have a reduced size and thickness. Research and development of various winding types or thin film types of coil components have been actively conducted to satisfy such requirements.

In a coupled inductor having an advantage of reducing a mounting area of a coil component, when two or more coils are arranged in a horizontal direction with respect to a mounting surface of the component, an area loss of a core may occur, and inductor properties may not be sufficiently secured.

### SUMMARY

An aspect of the present disclosure is to lower DC resistance (R_{dc}) of a coil component using area loss of a core.

According to an aspect of the present disclosure, there is provided a coil component including a body, a first coil and a second coil disposed within the body to be spaced apart from each other in a first direction, a plurality of first conductive vias connecting the first and second coils to each other, a third coil and a fourth coil disposed within the body to be spaced apart from each other in the first direction, a plurality of second conductive vias connecting the third and fourth coils to each other, first and second external electrodes disposed on the body and respectively connected to the first and second coils, and third and fourth external electrodes disposed on the body and respectively connected to the third and fourth coils.

The first coil may include a plurality of first pads connected to the plurality of first conductive vias and a first connection portion disposed between the plurality of first pads, the first connection portion having a line width narrower than that of the first pad. The second coil may include a plurality of second pads connected to the plurality of first conductive vias and a second connection portion disposed between the plurality of second pads, the second connection portion having a line width narrower than that of the second pad.

The first connection portion and the second connection portion may overlap each other in the first direction.

The third coil may include a plurality of third pads connected to the plurality of second conductive vias and a third connection portion disposed between the plurality of third pads, the third connection portion having a line width narrower than that of the third pad. The fourth coil may include a plurality of fourth pads connected to the plurality of second conductive vias and a fourth connection portion disposed between the plurality of fourth pads, the fourth connection portion having a line width narrower than that of the fourth pad.

The third connection portion and the fourth connection portion may overlap each other in the first direction.

The first coil and the second coil may be spaced apart from each other in a second direction, different from the first direction. The third coil and the fourth coil may be spaced apart from each other in the second direction.

The body may have a first surface and a second surface opposing each other in the second direction, the first surface and the second surface respectively adjacent to the first coil and the second coil, and a third surface and a fourth surface opposing each other in a third direction, different from the second direction and the first direction. One end of the first coil may be connected to the first external electrode on the first surface or the third surface of the body. One end of the second coil may be connected to the second external electrode on the second surface or the third surface of the body.

The one end of the first coil may be connected to the first external electrode on the first surface and the third surface of the body. The one end of the second coil may be connected to the second external electrode on the second surface and the third surface of the body.

One end of the third coil may be connected to the third external electrode on the second surface or the fourth surface of the body. One end of the fourth coil may be connected to the fourth external electrode on the first surface or the fourth surface of the body.

One end of the third coil may be connected to the third external electrode on the second surface and the fourth surface of the body. One end of the fourth coil may be connected to the fourth external electrode on the first surface and the fourth surface of the body.

At least one of the first to fourth coils may have a side surface toward an innermost turn from an outer turn adjacent to the innermost turn. The side surface may have a concave portion. At least one of the first to fourth pads may have at least a portion disposed in the concave portion.

A portion of the third coil may be disposed between an outermost turn and an inner turn, adjacent to the outermost turn, of the first coil. A portion of the first coil may be disposed between an outermost turn and an inner turn, adjacent to the outermost turn, of the third coil.

The first coil and the second coil may have an asymmetrical structure with respect to the first direction. The third coil and the fourth coil may have an asymmetrical structure with respect to the first direction.

The first coil and the second coil may have different numbers of turns.

The first coil may have one or more turns. The second coil may have less than one turn.

The third coil and the fourth coil may have different numbers of turns.

The third coil may have one or more turns. The fourth coil may have less than one turn.

Each of the first coil and the second coil may have more than one turn. Each of the third coil and the fourth coil may have more than one turn.

Each of the first coil and the second coil may have more than two turns. Each of the third coil and the fourth coil may have more than two turns.

The coil component may further include a first additional pattern connected to the first coil by a first additional via.

The first additional pattern may be disposed on a level substantially the same as that of the second coil with respect to the first direction.

The second coil may have less than one turn.

The coil component may further include a second additional pattern connected to the third coil by a second additional via.

The second additional pattern may be disposed on a level substantially the same as that of the fourth coil with respect to the first direction.

The fourth coil may have less than one turn.

A portion of an innermost turn of the first coil may have a first line width increasing region having a line width wider than that of an outer turn of the first coil.

The first line width increasing region may have a line width wider than that of an innermost turn of the second coil.

The first line width increasing region may be spaced apart from the plurality of first conductive vias.

The innermost turn of the first coil and an innermost turn of the second coil may respectively have a first overlapping region and a second overlapping region overlapping each other in the first direction. The first overlapping region and the first line width increasing region may oppose each other in a second direction, different from the first direction.

A portion of an innermost turn of the third coil may have a second line width increasing region having a line width wider than that of an outer turn of the third coil.

The second line width increasing region may have a line width wider than that of an innermost turn of the fourth coil.

The second line width increasing region may be spaced apart from the plurality of second conductive vias.

The innermost turn of the third coil and an innermost turn of the fourth coil may respectively have a third overlapping and a region fourth overlapping region overlapping each other in the first direction. The third overlapping region and the second line width increasing region may oppose each other in a second direction, different from the first direction.

According to another aspect of the present disclosure, there is provided a coil component including a body, a first coil and a second coil disposed within the body to be spaced apart from each other in a first direction, a first conductive via connecting the first and second coils to each other, a third coil and a fourth coil disposed within the body to be spaced apart from each other in the first direction, a second conductive via connecting the third and fourth coils to each other, first and second external electrodes disposed on the body and respectively connected to the first and second coils, and third and fourth external electrodes disposed on the body and respectively connected to the third and fourth coils. An innermost turn of the first coil and an innermost turn of the second coil respectively have a first overlapping region and a second overlapping region overlapping each other in the first direction. Each of the first overlapping region and the second overlapping region has a quarter turn more.

An innermost turn of the third coil and an innermost turn of the fourth coil may respectively have a third overlapping and a region fourth overlapping region overlapping each other in the first direction. Each of the third overlapping region and the fourth overlapping region may have a quarter turn or more.

According to another aspect of the present disclosure, there is provided a coil component including a body, a first coil and a second coil disposed within the body to be spaced apart from each other in a first direction, a first conductive via connecting the first and second coils to each other, a third coil and a fourth coil disposed within the body to be spaced apart from each other in the first direction, a second conductive via connecting the third and fourth coils to each other, first and second external electrodes disposed on the body and respectively connected to the first and second coils, and third and fourth external electrodes disposed on the body and respectively connected to the third and fourth coils. A portion of an innermost turn of the first coil has a first line width increasing region having a line width wider than that of an outer turn of the first coil.

A portion of an innermost turn of the third coil may have a second line width increasing region having a line width wider than that of an outer turn of the third coil.

According to another aspect of the present disclosure, there is provided a coil component including a body, a first coil and a second coil disposed within the body to be spaced apart from each other in a first direction, a first conductive via connecting the first and second coils to each other, a third coil and a fourth coil disposed within the body to be spaced apart from each other in the first direction, a second conductive via connecting the third and fourth coils to each other, a first additional pattern connected to the first coil by a first additional via, first and second external electrodes disposed on the body and respectively connected to the first and second coils, and third and fourth external electrodes disposed on the body and respectively connected to the third and fourth coils.

The first additional pattern may be disposed on a level substantially the same as that of the second coil with respect to the first direction.

The second coil may have less than one turn.

The coil component may further include a second additional pattern connected to the third coil by a second additional via.

The second additional pattern may be disposed on a level substantially the same as that of the fourth coil with respect to the first direction.

The fourth coil may have less than one turn.

According to another aspect of the present disclosure, there is provided a coil component including a body, support member disposed in the body, a first coil and a second coil disposed on opposing surfaces of the support member and in the body, a plurality of conductive vias penetrating through the support member to connect the first and second coils to each other, and first and second external electrodes disposed on the body and respectively connected to the first and second coils.

The first coil may include a plurality of first pads connected to the plurality of conductive vias and a first connection portion disposed between the plurality of first pads, the first connection portion having a line width narrower than that of the plurality of first pads. The second coil may include a plurality of second pads connected to the plurality of conductive vias and a second connection portion disposed between the plurality of second pads, the second connection portion having a line width narrower than that of the plurality of second pads.

The first connection portion and the second connection portion may overlap each other in a stacking direction of the first and second coils.

A region where the plurality of first pads and the first connection portion are disposed may have a quarter turn or more.

At least one of the first and second coils may have a side surface toward an innermost turn from an outer turn adjacent to the innermost turn. The side surface may have a concave portion. At least one of the first and second pads has at least a portion disposed in the concave portion.

A portion of an innermost turn of the first coil has a first line width increasing region having a line width wider than that of an outer turn of the first coil.

The first line width increasing region may be spaced apart from the plurality of first conductive vias.

According to an example embodiment of the present disclosure, a coil component may have lowered DC resistance (R_{dc}) using an area loss of a core.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic transparent perspective view of a coil component according to a first example embodiment of the present disclosure; and

FIGS. 2 and 3 are top plan views of the coil component of FIG. 1, and respectively illustrate an upper coil and a lower coil with respect to a support member;

FIGS. 4 to 7, modifications of a coil component according to a first example embodiment, are top plan views of the coil component;

FIGS. 8 and 9, other modifications of a coil component according to a first example embodiment, are top plan views of the coil component;

FIGS. 10 and 11 are top plan views of a coil component according to a second example embodiment, and respectively illustrate an upper coil and a lower coil with respect to a support member;

FIGS. 12 and 13, modifications of a coil component according to a second example embodiment, are top plan views of the coil component;

FIGS. 14 and 15 are top plan views of a coil component according to a third example embodiment, and respectively illustrate an upper coil and a lower coil with respect to a support member; and

FIGS. 16 and 17, modifications of a coil component according to a third example embodiment, are top plan views of the coil component.

### DETAILED DESCRIPTION

Hereinafter, example embodiments of the present disclosure are described with reference to the accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

Various types of electronic components may be used in electronic devices, and various types of coil components may be appropriately used between such electronic components to remove noise. That is, in an electronic device, a coil component may be used as a power inductor, a high-frequency (HF) inductor, a general bead, a high-frequency bead (GHz bead), a common mode filter, and the like.

### First Example Embodiment

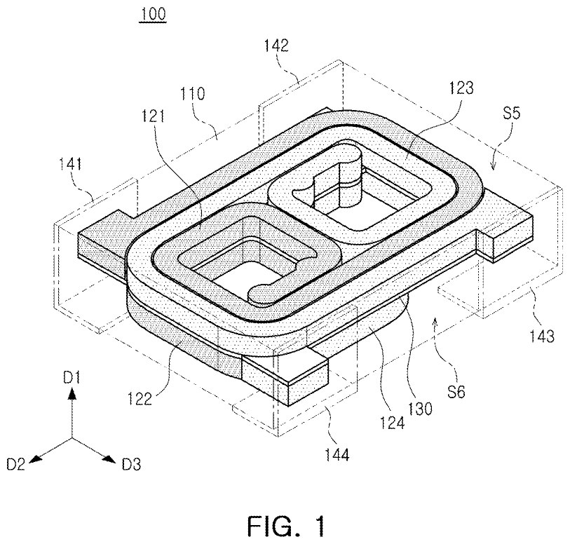

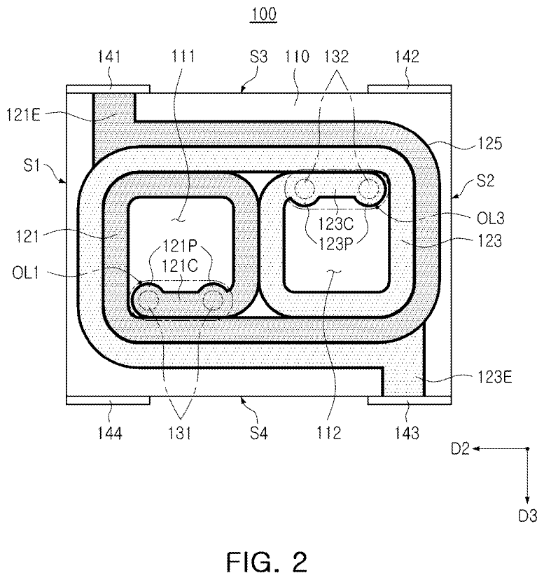

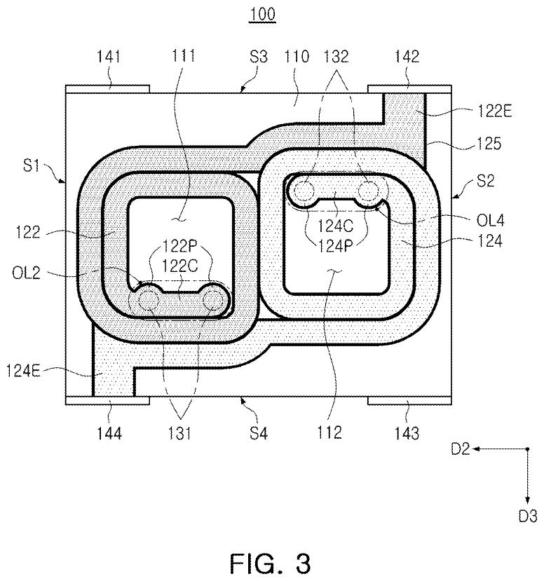

FIG. 1 is a schematic perspective view of a coil component according to a first example embodiment of the present disclosure. FIGS. 2 and 3 are top plan views of the coil component of FIG. 1, and respectively illustrate an upper coil and a lower coil with respect to a support member.

Referring to FIGS. 1 to 3, a coil component 100 according to a first example embodiment of the present disclosure may include a body 110, first to fourth coils 121, 122, 123, and 124, and a plurality of first conductive vias 131, a plurality of second conductive vias 132, and first to fourth external electrodes 141, 142, 143, and 144.

Here, the plurality of first conductive vias 131 may connect the first and second coils 121 and 122 to each other, and the plurality of second conductive vias 132 may connect the third and fourth coils 123 and 124 to each other. In the present example embodiment, a parallel connection structure may be implemented in which coils are connected to each other by a plurality of vias, thereby improving electrical properties (reducing R_{dc}). Hereinafter, main elements included in the coil component 100 according to the present example embodiment will be described.

The first to fourth coils 121, 122, 123, and 124 may be disposed within the body 110, and the body 110 may form the overall exterior of the coil component 100. The body 110 may have a fifth surface S5 and a sixth surface S6, opposing each other in a first direction (direction D1), and a plurality of side surfaces (first to fourth surfaces), connecting the fifth surface S5 and the sixth surface S6 to each other. Specifically, the first and second surfaces S1 and S2 may oppose each other in a second direction (direction D2), and may connect the fifth and sixth surfaces S5 and S6 to each other, and the third and fourth surfaces S3 and S4 may oppose each other in a third direction (direction D3), and may connect the fifth and sixth surfaces S5 and S6 to each other. Here, the first direction (direction D1), the second direction (direction D2), and the third direction (direction D3) may be perpendicular to each other. In addition, the first direction (direction D1) may correspond to a thickness direction of the body 110 and the support member 130. In the description below, each of the first direction (D1 direction), the second direction (D2 direction), and the third direction (D3 direction) may represent both directions, and may include, for example, both an upward direction and a downward direction.

The body 110 may include a resin and a magnetic material. Specifically, the body 110 may be formed by laminating one or more magnetic composite sheets in which a magnetic material is dispersed in a resin. The magnetic material may be ferrite or metal magnetic powder particles. The ferrite powder particles may be, for example, at least one of spinel-type ferrite powder particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite powder particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite powder particles such as Y-based ferrite powder particles or the like, and Li-based ferrite powder particles. The magnetic metal powder particles may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the magnetic metal powder particles may be at least one of pure iron powder particles, Fe—Si-based alloy powder particles, Fe—Si—Al-based alloy powder particles, Fe—Ni-based alloy powder particles, Fe—Ni—Mo-based alloy powder particles, Fe—Ni—Mo—Cu-based alloy powder particles, Fe—Co-based alloy powder particles, Fe—Ni—Co-based alloy powder particles, Fe—Cr-based alloy powder particles, Fe—Cr—Si-based alloy powder particles, Fe—Si—Cu—Nb-based alloy powder particles, Fe—Ni—Cr-based alloy powder particles, and Fe—Cr—Al-based alloy powder particles. The magnetic metal powder particles may be amorphous or crystalline. For example, the magnetic metal powder particles may be Fe—Si—B—Cr-based amorphous alloy powder particles, but the present disclosure is not necessarily limited thereto. Each of the ferrite powder particles and the magnetic metal powder particles may have an average diameter of about 0.1 μm to about 30 μm, but the present disclosure is not limited thereto. The body 110 may include two or more types of magnetic materials dispersed in the resin. Here, different types of magnetic materials mean that the magnetic materials dispersed in the resin are distinguished from each other by one of an average diameter, a composition, crystallinity, and a shape. The resin may include epoxy, polyimide, a liquid crystal polymer, or the like alone or in combination, but the present disclosure is not limited thereto.

With respect to one example of a manufacturing method, the body 110 may be formed by a lamination method. Specifically, a plurality of unit laminates for manufacturing the body 110 may be laminated on upper portions and lower portions of the first to fourth coils 121, 122, 123, and 124. Here, a slurry may be prepared by mixing magnetic particles such as metal and organic materials such as a thermosetting resin, a binder, and a solvent, and the slurry may be coated on a carrier film at a thickness of several tens of μm using a doctor blade method, and then dried to manufacture the unit laminate in the form of a sheet. Accordingly, the unit laminate may be manufactured in a form in which magnetic particles are dispersed in a thermosetting resin such as an epoxy resin or polyimide.

The support member 130 may support the first to fourth coils 121, 122, 123, and 124 to be described below, and may be formed of, for example, a polypropylene glycol (PPG) substrate, a ferrite substrate, or a metal-based soft magnetic substrate. However, in some example embodiments, the support member 130 may not be provided. For example, when a winding-type coil is used, the support member 130 may not be separately required. As illustrated, a portion of the support member 130 may be penetrated to form a through-hole, and a material of the body 110 may be filled in the through-hole. Accordingly, a first core 111 may be formed in the first and second coils 121 and 122, and a second core 112 may be formed in the third and fourth coils 123 and 124.

The coil component 100 according to the present example embodiment may include the first to fourth coils 121, 122, 123, and 124. That is, the coil component according to the present example embodiment may be in the form of an array, and specifically, may be a coupled inductor. However, the present disclosure is not necessarily limited thereto.

As will be described below, the first and third coils 121 and 123 may be spaced apart from each other in a second direction (direction D2) in a state of being disposed on substantially the same level with respect to the first direction (direction D1). The second and fourth coils 122 and 124 may be spaced apart from each other in the second direction (direction D2) in a state of being disposed on substantially the same level with respect to the first direction (direction D1). That is, the coil component 100 according to the present example embodiment may be a coil array in which coils are arranged in a horizontal direction.

The first and second coils 121 and 122 may be disposed within the body 110 to be spaced apart from each other in a first direction (direction D1), parallel to the central axis. Specifically, the first coil 121 may be disposed on a first surface (upper surface with respect to the drawings) of the support member 130, and the second coil 122 may be disposed on a second surface (lower surface with respect to the drawings) of the support member 130. The first coil 121, disposed on the first surface, may also be referred to as an upper coil, and the second coil 122, disposed on the second surface, may also be referred to as a lower coil.

In order to connect the first coil 121 and the second coil 122 to each other, the first coil 121 may include a plurality of first pads 121P respectively connected to the plurality of first conductive vias 131, and a first connection portion 121C disposed between the plurality of first pads 121P. The plurality of first pads 121P and the first connection portion 121C, disposed between the plurality of first pads 121P, may be formed on an innermost turn of the first coil 121 and correspond to the other end of the first coil 121. Similarly, the second coil 122 may include a plurality of second pads 122P respectively connected to the plurality of first conductive vias 131, and a second connection portion 122C disposed between the plurality of second pads 122P. The plurality of second pads 122P and the second connection portion 122C, disposed between the plurality of second pads 122P, may be formed on an innermost turn of the second coil 122 and correspond to the other end of the second coil 122. The plurality of first conductive vias 131 will be described below.

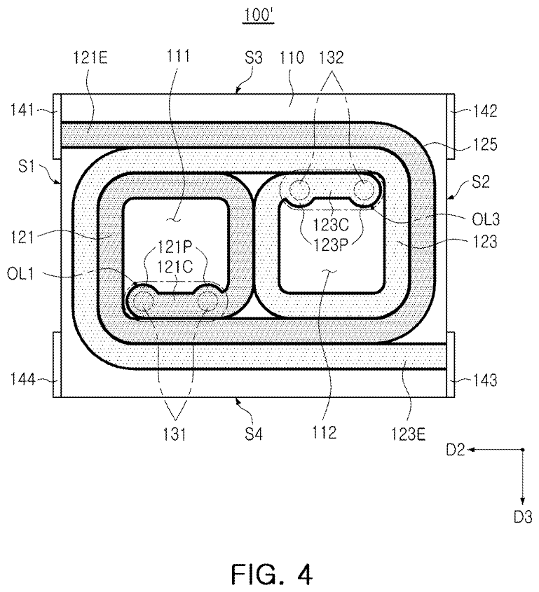

One ends of the first coil 121 and the second coil 122 may be respectively connected to a first external electrode 141 and a second external electrode 142 to be described below. Specifically, one end 121E of the first coil 121 may be connected to the first external electrode 141 on the first surface S1 or the third surface S3 of the body 110, and one end 122E of the second coil 122 may be connected to the second external electrode 142 on the second surface S2 or the third surface S3 of the body 110. Referring to FIGS. 2 and 3, the one end 121E of the first coil 121 may extend to the third surface S3 of the body 110 to be connected to the first external electrode 141, and the one end 122E of the second coil 122 may extend to the third surface S3 of the body 110 to be connected to the second external electrode 142. However, the present disclosure is not limited thereto, and a connection between a coil and an external electrode may have various structures, as in modifications (FIGS. 4 to 7) to be described below.

In addition, the other ends of the first and second coils 121 and 122 may be connected to each other by the plurality of first conductive vias 131 to be described below. Specifically, the plurality of first pads 121P and the plurality of second pads 122P may be connected by the first conductive via 131.

Each of the first coil 121 and the second coil 122 may form at least one turn with respect to a central axis. The central axis may be parallel to a first direction (direction D1) of the body 110. Specifically, each of the first coil 121 and the second coil 122 may have more than one turn. However, the present disclosure is not limited thereto, and each of the first coil 121 and the second coil 122 may have more than two turns. Alternatively, the first coil 121 may have one or more turns, and the second coil 122 may have less than one turn. Alternatively, the number of turns of the first coil 121 and the number of turns of the second coil 122 may be substantially the same. Various numbers of turns of a coil will be described in another example embodiment of the present disclosure.

The first connection portion 121C may have a line width narrower than that of the first pad 121P, and the second connection portion 122C may have a line width narrower than that of the second pad 122P. The coil component according to the present example embodiment may include the pads 121P and 122P having an increased width, thereby further improving connectivity between the coils 121 and 122.

A line width of a connection portion may be measured using the following method. In a coil component according to the first example embodiment, the line width may be obtained by taking a cross-sectional sample of the coil component in a first direction (direction D1)-third direction (direction D3), passing through the connection portion, and measuring a distance between side surfaces of the connection portion. Here, the side surfaces of the connection portion may refer to a surface toward an outer turn from the connection portion, and a surface toward a core from the connection portion. By analogy with the above method, a line width of a pad may also be measured.

In a coil array in which coils are arranged in a horizontal direction, the upper coils 121 and 123 and the lower coils 122 and may be staggered (may have an asymmetrical structure), resulting in an area loss of a core. In the coil component according to the present example embodiment, portions of an innermost turn of a coil may overlap each other, and area loss of a core can be minimized.

Specifically, the first connection portion 121C and the second connection portion 122C may overlap each other in the first direction (direction D1).

In the case that the first connection portion 121C and the second connection portion 122C overlap each other in the first direction (direction D1), when the coil component 100 is viewed in the first direction (direction D1), the second connection portion 122C may be covered by the first connection portion 121C, and accordingly may not be visible. Alternatively, conversely, the first connection portion 121C may be covered by the second connection portion 122C, and accordingly may not be visible.

The innermost turn of the first coil 121 and the innermost turn of the second coil 122 may respectively have a first overlapping region OL1 and a second overlapping region OL2, overlapping each other in the first direction (direction D1). Here, an overlapping region OL may form a continuous region without being disconnected from each of the coils 121 and 122, and may refer to a region of an overlapping portion, adjacent to the other end of each of the coils 121 and 122, when the coils 121 and 122 are viewed in the first direction (direction D1). The first connection portion 121C and the plurality of first pads 121P may be positioned in the first overlapping region OL1, and the second connection portion 122C and the plurality of second pads 122P may be positioned in the second overlapping region OL2.

Each of the first overlapping region OL1 and the second overlapping region OL2 may form a quarter turn or more. Here, the quarter turn may mean a case in which an angle formed by both ends and a central axis is 90°, ¼ of 360°, that is, an angle corresponding to one turn. When each of the first overlapping region OL1 and the second overlapping region OL2 forms a quarter turn or more as in the present example embodiment, a loss area of the core 111 may be maximally used to distribute coil conductors over a wasted area, thereby lowering DC resistance (R_{dc}). However, the present disclosure is not limited thereto, and a length of an overlapping region may be determined in consideration of a DC resistance (R_{dc}) reduction effect. Specifically, referring to FIGS. 2 and 3, each of the first overlapping region OL1 and the second overlapping region OL2 may form a quarter turn or more. When viewed in the first direction (direction D1), the innermost turns of the coils 121 and 122 may overlap each other except for a small portion. That is, the coils 121 and 122 may be maximally disposed in a region not included in the core 111.

The first coil 121 and the second coil 122 may have an asymmetrical structure therebetween with respect to the first direction (direction D1). Hereinafter, the asymmetrical structure between the first coil 121 and the second coil 122 will be described.

The first coil 121 may be disposed to be adjacent to the second surface S2 of the body 110, and the second coil 122 may be disposed to be adjacent to the first surface S1 of the body 110. Here, “being adjacent” may refer to being disposed to be closest to an arbitrary surface without being in contact with the arbitrary surface of the body 110. Specifically, referring to FIGS. 2 and 3, the first coil 121 may be disposed to be closer to the second surface S2 than to the first surface S1 of the body 110, and the second coil 122 may be disposed to be closer to the first surface S1 than to the second surface S2 of the body 110.

Hereinafter, as in a second example embodiment to be described below, the first coil 121 and the second coil 122 may have different numbers of turns.

The first coil 121 and the second coil 122 may have different winding directions with respect to the central axis. In addition, as illustrated in FIGS. 4 to 7, one ends of the first coil 121 and the second coil 122 may respectively extend to the first and second surfaces S1 and S2 of the body 110.

The plurality of first conductive vias 131 may connect the first coil 121 and the second coil 122 to each other. The plurality of first conductive vias 131 may pass through the support member 130. The plurality of first conductive vias 131 may connect the innermost turn of the first coil 121 and the innermost turn of the second coil 122 to each other. For example, one of the plurality of first conductive vias 131 may be connected to the other end of the first coil 121, and the other thereof may be connected to the other end of the second coil 122. As in the present example embodiment, when the first and second coils 121 and 122 are connected to each other via the plurality of conductive vias 131, a structure of a parallel connection between coils may be implemented, thereby improving electrical properties, specifically, R_{dc} properties (reducing R_{dc}).

Referring to FIGS. 2 and 3, the number of first conductive vias 131 is illustrated as two, but the present disclosure is not limited thereto. The number of first conductive vias may be increased to three or more, thereby further reducing Rac of the coil component 100.

Hereinafter, the third and fourth coils 123 and 124 and the second conductive via 132 will be described, and the description of the first and second coils 121 and 122 and the first conductive via 131 may be inferred.

The third and fourth coils 123 and 124 may be disposed within the body 110 to be spaced apart from each other in a first direction (direction D1). Specifically, the third coil 123 may be disposed on a first surface (upper surface with respect to the drawings) of the support member 130, and the fourth coil 124 may be disposed on a second surface (lower surface with respect to the drawings) of the support member 130. The third coil 123, disposed on the first surface, may also be referred to as an upper coil, and the fourth coil 124, disposed on the second surface, may also be referred to as a lower coil.

The third coil 123 may be disposed to be spaced apart from the first coil 121 in a second direction (direction D2) of the body 110, and the fourth coil 124 may be disposed to be spaced apart from the second coil 122 in the second direction (direction D2) of the body 110. That is, the first and third coils 121 and 123 may be disposed to be spaced apart from each other in the second direction (direction D2) on an upper surface of the support member 130, and the second and fourth coils 122 and 124 may be disposed to be spaced apart from each other in the second direction (direction D2) on a lower surface of the supporting member 130.

In order to connect the third coil 123 and the fourth coil 124 to each other, the third coil 123 may include a plurality of third pads 123P respectively connected to the plurality of second conductive vias 132, and a third connection portion 123C disposed between the plurality of third pads 123P. The plurality of third pads 123P and the third connection portion 123C, disposed between the plurality of third pads 123P, may be formed on an innermost turn of the third coil 123 and correspond to the other end of the third coil 123. Similarly, the fourth coil 124 may include a plurality of fourth pads 124P respectively connected to the plurality of second conductive vias 132, and a fourth connection portion 124C disposed between the plurality of fourth pads 124P. The plurality of fourth pads 124P and the fourth connection portion 124C, disposed between the plurality of fourth pads 124, may be formed on an innermost turn of the fourth coil 124 and correspond to the other end of the fourth coil 124. The plurality of second conductive vias 132 will be described below.

One ends of the third coil 123 and the fourth coil 124 may be respectively connected to a third external electrode 143 and a fourth external electrode 144 to be described below. Specifically, one end 123E of the third coil 123 may be connected to the third external electrode 143 on the second surface S2 or the fourth surface S4 of the body 110, and one end 124E of the fourth coil 124 may be connected to the fourth external electrode 144 on the first surface S1 or the fourth surface S4 of the body 110. Referring to FIGS. 2 and 3, the one end 123E of the third coil 123 may extend to the fourth surface S4 of the body 110 to be connected to the third external electrode 143, and the one end 124E of the fourth coil 122 may extend to the fourth surface S4 of the body 110 to be connected to the fourth external electrode 144. However, the present disclosure is not limited thereto, and a connection between a coil and an external electrode may have various structures, as in modifications (FIGS. 4 to 7) to be described below.

In addition, the other ends of the third and fourth coils 123 and 124 may be connected to each other by the plurality of second conductive vias 132. Specifically, the plurality of third pads 123P and the plurality of fourth pads 124P may be connected to each other by the second conductive via 132.

Each of the third coil 123 and the fourth coil 124 may form at least one turn with respect to a central axis. Specifically, each of the third coil 123 and the fourth coil 124 may have more than one turn. However, the present disclosure is not limited thereto, and each of the third coil 123 and the fourth coil 124 may have more than two turns. Alternatively, the third coil 123 may have one or more turns, and the fourth coil 124 may have less than one turn. Alternatively, the number of turns of the third coil 123 and the number of turns of the fourth coil 124 may be substantially the same. Various numbers of turns of a coil will be described in another example embodiment of the present disclosure.

A portion of the third coil 123 may be disposed between an outermost turn and an inner turn, adjacent to the outermost turn, of the first coil 121. In addition, a portion of the first coil 121 may be disposed between an outermost turn and an inner turn, adjacent to the outermost turn, of the third coil 123. That is, the first coil 121 and the third coil 123 may be alternately disposed with the cores 111 and 112 therebetween. However, the present disclosure is not limited thereto.

The third connection portion 123C may have a line width narrower than that of the third pad 123P, and the fourth connection portion 124C may have a line width narrower than that of the second pad 124P. The coil component according to the present example embodiment may include the pads 123P and 124P having an increased width, thereby further improving connectivity between the coils 123 and 124.

The third connection portion 123C and the fourth connection portion 124C may overlap each other in the first direction (direction D1).

In the case that the third connection portion 123C and the fourth connection portion 124C overlap each other in the first direction (direction D1), when the coil component 100 is viewed in the first direction (direction D1), the fourth connection portion 124C may be covered by the third connection portion 123C, and accordingly may not be visible. Alternatively, conversely, the third connection portion 123C may be covered by the fourth connection portion 124C, and accordingly may not be visible.

The innermost turn of the third coil 123 and the innermost turn of the fourth coil 124 may respectively have a third overlapping region OL3 and a fourth overlapping region OL4, overlapping each other in the first direction (direction D1). Here, an overlapping region OL may form a continuous region without being disconnected from each of the coils 123 and 124, and may refer to a region of an overlapping portion, adjacent to the other end of each of the coils 123 and 124, when the coils 123 and 124 are viewed in the first direction (direction D1). The third connection portion 123C and the plurality of third pads 123P may be positioned in the third overlapping region OL3, and the fourth connection portion 124C and the plurality of fourth pads 124P may be positioned in the fourth overlapping region OL4.

Each of the third overlapping region OL3 and the fourth overlapping region OL4 may form a quarter turn or more. In this case, a loss area of the core 112 may be maximally used to distribute coil conductors over a wasted area, thereby lowering DC resistance (R_{dc}). However, the present disclosure is not limited thereto, and a length of an overlapping region may be determined in consideration of a DC resistance (R_{dc}) reduction effect. Specifically, referring to FIGS. 2 and 3, each of the third overlapping region OL3 and the fourth overlapping region OL4 may form a quarter turn or more. When viewed in the first direction (direction D1), the innermost turns of the coils 123 and 124 may overlap each other except for a small portion. That is, the coils 123 and 124 may be maximally disposed in a region not included in the core 112.

The third coil 123 and the fourth coil 124 may have an asymmetrical structure therebetween with respect to the first direction (direction D1). Hereinafter, the asymmetrical structure between the third coil 123 and the fourth coil 124 will be described.

The third coil 123 may be disposed to be adjacent to the first surface S1 of the body 110, and the fourth coil 124 may be disposed to be adjacent to the second surface S2 of the body 110. Here, “being adjacent” may refer to being disposed to be closest to an arbitrary surface of the body 110 without being in contact with the arbitrary surface. Specifically, referring to FIGS. 2 and 3, the third coil 123 may be disposed to be closer to the first surface S1 than the second surface S2 of the body 110, and the fourth coil 124 may be disposed to be closer to the second surface S2 than the first surface S1 of the body 110.

Hereinafter, as in the second example embodiment to be described below, the third coil 123 and the fourth coil 124 may have different numbers of turns.

The third coil 123 and the fourth coil 124 may have different winding directions based on the central axis. In addition, as illustrated in FIGS. 4 to 7, one ends of each of the third coil 123 and the fourth coil 124 may extend to the second surface S2 and the second surface S1 of the body 110.

The plurality of second conductive vias 132 may connect the third coil 123 and the fourth coil 124 to each other. The plurality of second conductive vias 132 may pass through the support member 130. The plurality of second conductive vias 132 may connect an innermost turn of the third coil 123 and an innermost turn of the fourth coil 124 to each other. For example, one of the plurality of second conductive vias 132 may be connected to the other end of the third coil 123, and the other one may be connected to the other end of the fourth coil 124. As in the present example embodiment, when the third and fourth coils 123 and 124 are connected to each other via the plurality of conductive vias 132, a structure of a parallel connection between coils may be implemented, thereby improving electrical properties, specifically, R_{dc} properties (reducing R_{dc}).

Referring to FIGS. 2 and 3, the number of second conductive vias 132 is illustrated as two, but the present disclosure is not limited thereto. The number of second conductive vias may be increased to three or more, thereby further reducing R_{dc} of the coil component 100.

The coils 121, 122, 123, and 124 may have a plating pattern formed using plating processes used in the art, for example, methods such as pattern plating, anisotropic plating, isotropic plating, and the liker, and may also be formed to have a multilayer structure using a plurality of processes, among the processes. As an example of a material included in the coils 121, 122, 123, and 124, a conductive material such as copper (Cu), aluminum (Al), silver (Ag), tin (Sn), gold (Au), nickel (Ni), lead (Pb), titanium (Ti), chromium (Cr), or alloys thereof may be used, but the present disclosure is not limited thereto.

An insulating film 125 may be formed on surfaces of the coils 121, 122, 123, and 124. The insulating film 125 may integrally cover the coils 121, 122, 123, and 124 and the support member 130. Specifically, the insulating film 125 may be disposed between the coils 121, 122, 123, and 124 and the body 110 and between the support member 130 and the body 110. The insulating film 125 may be formed along a surface of the support member 130 on which the coils 121, 122, 123, and 124 are formed, but the present disclosure is not limited thereto. The insulating film 125 may charge regions such as between adjacent turns of the coils 121, 122, 123, and 124. The insulating film 125 may be used to electrically isolate the coils 121, 122, 123, and 124 from the body 110, and may include a known insulating material such as parylene, but the present disclosure is not limited thereto. For another example, the insulating layer 125 may include an insulating material such as an epoxy resin other than parylene. The insulating film 125 may be formed using a vapor deposition, but the present disclosure is not limited thereto. For another example, the insulating film 125 may be formed by laminating and curing an insulating film for forming a coil insulating film on both surfaces of the support member 130 on which the coils 121, 122, 123, and 124 are formed, and may be formed by coating and curing an insulating paste for forming an insulating film on both surfaces of the support member 130 on which the coils 121, 122, 123, and 124 are formed. For the reasons described above, the insulating film 125 may be omitted in the present example embodiment. That is, when the body 110 has sufficient electrical resistance at a designed operating current and voltage of the coil component 100, the insulating film 125 may be omitted in the present example embodiment.

The first to fourth external electrodes 141, 142, 143, and 144 may be disposed on the body 110, and may be respectively connected to the first to fourth coils 121, 122, 123, and 124. Specifically, the first to fourth external electrodes 141, 142, 143, and 144 may be respectively connected to one ends 121E, 122E, 123E, and 124E of respective coils. Hereinafter, an arrangement of external electrodes will be described.

The first external electrode 141 may be disposed on the first surface S1 or the third surface S3 of the body 110. The second external electrode 142 may be disposed on the second surface S2 or the third surface S3 of the body 110. The third external electrode 143 may be disposed on the second surface S2 or the fourth surface S4 of the body 110. The fourth external electrode 144 may be disposed on the first surface S1 or the fourth surface S4 of the body 110.

In addition, the first to fourth external electrodes may extend to the fifth surface S5 of the body 110. In this case, the fifth surface S5 of the body 110 may be provided as a mounting surface of the coil component 100.

The first to fourth external electrodes 141, 142, 143, and 144 may be formed using a paste including a metal having excellent electrical conductivity, for example, a conductive paste including nickel (Ni), copper (Cu), tin (Sn), or silver (Ag) alone or alloys thereof. In addition, a plating layer may be provided to cover each of the first to fourth external electrodes 141, 142, 143, and 144. In this case, the plating layer may include at least one selected from the group consisting of nickel (Ni), copper (Cu), and tin (Sn). For example, a nickel (Ni) layer and a tin (Sn) layer may be sequentially formed.

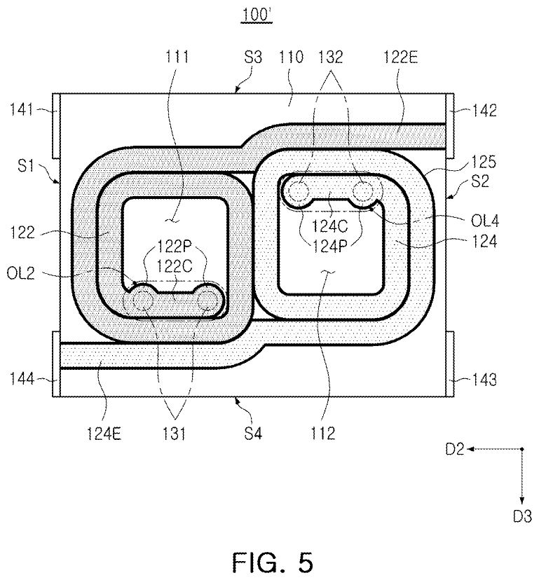

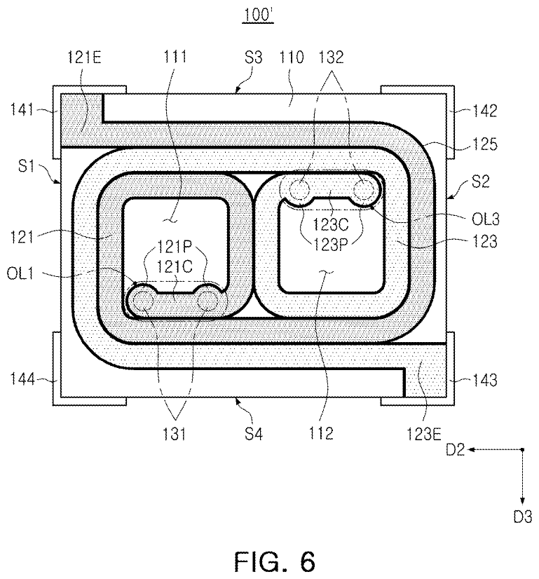

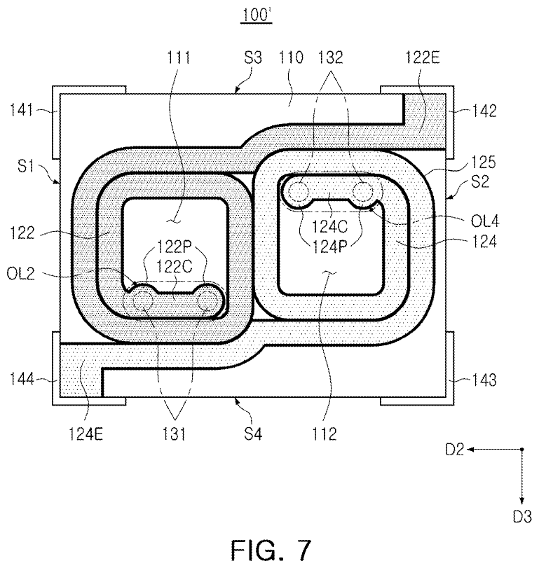

FIGS. 4 to 7, modifications of a coil component according to a first example embodiment, are top plan views of the coil component. FIGS. 4 and 6 illustrate an upper coil with respect to a support member, and FIGS. 5 and 7 illustrate a lower coil with respect to a support member.

Referring to FIGS. 4 to 7, when compared to FIGS. 1 to 3, surfaces of the external electrodes 141, 142, 143, and 144 to which coil ends 121E, 122E, 123E, and 124E, are connected may be different from each other.

Specifically, referring to FIGS. 4 and 5, it can be confirmed that one end 121E of a first coil is connected to a first external electrode 141 on a first surface S1 of a body 110, one end 122E of a second coil is connected to a second external electrode 142 on a second surface S2 of the body 110, one end 123E of a third coil is connected to a third external electrode 143 on the second surface S2 of the body 110, and one end 124E of a fourth coil is connected to a fourth external electrode 144 on the first surface S1 of the body 110.

In addition, referring to FIGS. 6 and 7, it can be confirmed that one end 121E of a first coil is connected to a first external electrode 141 on a first surface S1 and a third surface S3 of a body 110, one end 122E of a second coil is connected to a second external electrode 142 on a second surface S2 and the third surface S3 of the body 110, one end 123E of a third coil is connected to a third external electrode 143 on the second surface S2 and a fourth surface S4 of the body 110, and one end 124E of a fourth coil is connected to a fourth external electrode 144 on the first surface S1 and the fourth surface S4 of the body 110.

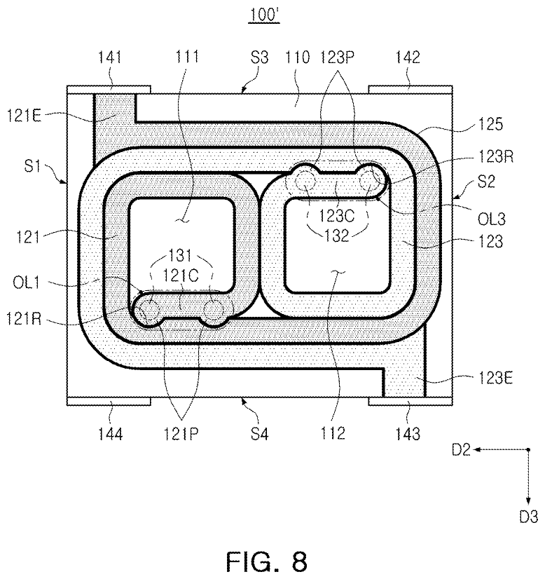

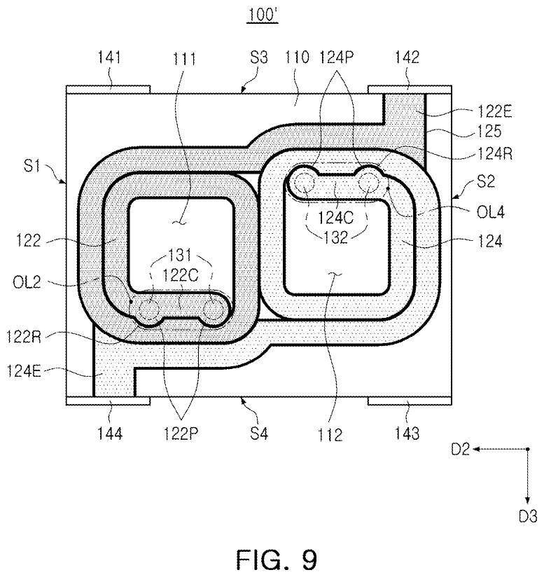

FIGS. 8 and 9, other modifications of a coil component according to a first example embodiment, are top plan views of the coil component. FIGS. 8 and 9 respectively illustrate an upper coil and a lower coil with respect to a support member.

When a plurality of conductive vias 131 and 132 are used, cores 111 and 112 may have a reduced size, and thus, magnetic properties of a coil component may be degraded. In the modifications, such a degradation in magnetic properties may be minimized by optimizing an arrangement of pads.

Referring to FIGS. 8 and 9, at least one of first to fourth coils may have a side surface thereof toward an innermost turn from an outer turn adjacent to the innermost turn, the side surface on which concave portions 121R, 122R, 123R, and 124R are formed. At least a portion of at least one of the first to fourth pads 121P, 122P, 123P, and 124P may be disposed in the concave portion 121R, 122R, 123R, and 124R.

### Second Example Embodiment

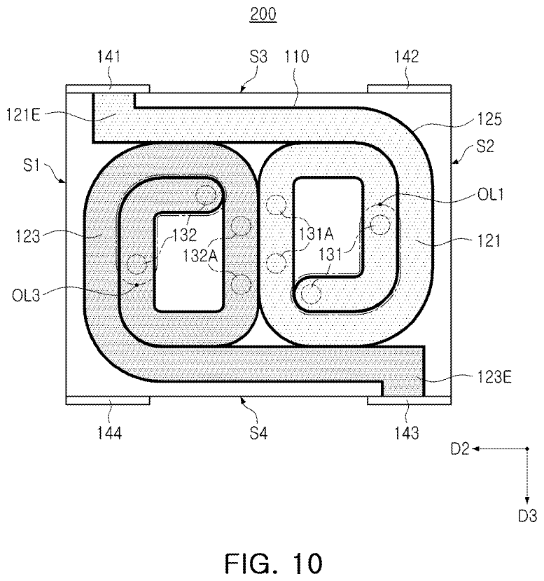

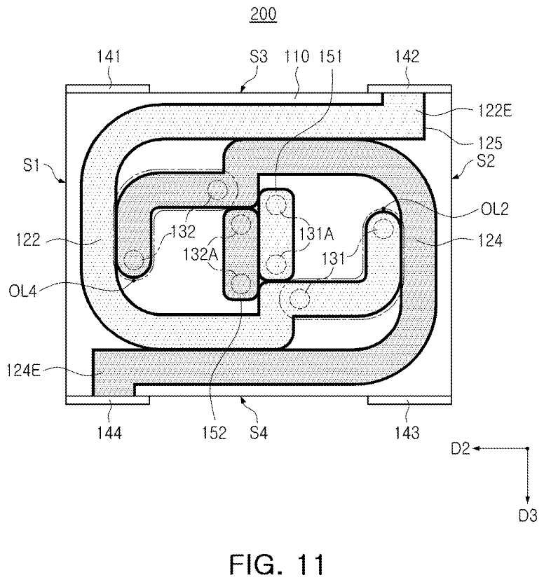

FIGS. 10 and 11 are top plan views of a coil component according to a second example embodiment, and respectively illustrate an upper coil and a lower coil with respect to a support member.

In a coil component 200 according to a second example embodiment, the number of turns of coils 121, 122, 123, and 124 may be different from each other, as compared to that in the first example embodiment. A first coil 121 and a second coil 122 may have different numbers of turns, and a third coil 123 and a fourth coil 124 may have different numbers of turns.

Specifically, the first and third coils 121 and 123 may have more than one turn. Conversely, the second and fourth coils 122 and 124 may have less than one turn.

When the number of turns of an upper coil and the number of turns of a lower coil are different from each other as in the second example embodiment, asymmetry between the upper and lower coils may increase, resulting in a larger loss area of a core. A coil conductor may be additionally disposed in such a wasted area, thereby further lowering DC resistance (R_{dc}).

The coil component 200 according to the second example embodiment may further include a first additional pattern 151 connected by a first additional via 131A or a second additional pattern 152 connected by a second additional via 132A. In the drawings, the coil component 200 is illustrated as including both the first additional pattern 151 and the second additional pattern 152, but the present disclosure is not necessarily limited thereto.

Specifically, the first additional pattern 151 may be disposed on a level substantially the same as that of the second coil 122 with respect to a first direction (direction D1). However, the present disclosure is not necessarily limited thereto, and the first additional pattern 151 may be disposed considering the number of turns of the first and second coils 121 and 122. For example, the first additional pattern 151 may be disposed on a level substantially the same as that of the first coil 121.

The first additional pattern 151 may not be directly connected to the second coil 122. That is, the first additional pattern 151 may be disposed to be spaced apart from a second surface of a support member 130 in the same manner as the second coil 122.

Similarly, the second additional pattern 152 may be disposed on a level substantially the same as that of the fourth coil 124 with respect to the first direction (direction D1). However, the present disclosure is not necessarily limited thereto, and the second additional pattern 152 may be disposed considering the number of turns of the third and fourth coils 123 and 124. For example, the second additional pattern 152 may be disposed on a level substantially the same as that of the third coil 123.

The second additional pattern 152 may not be directly connected to the fourth coil 124. That is, the second additional pattern 152 may be disposed to be spaced apart from the second surface of the support member 130 in the same manner as the fourth coil 124.

The first additional via 131A may pass through the support member 130 to connect the first coil 121 and the first additional pattern 151 to each other. Similarly, the second additional via 132A may pass through the support member 130 to connect the third coil 123 and the second additional pattern 152 to each other.

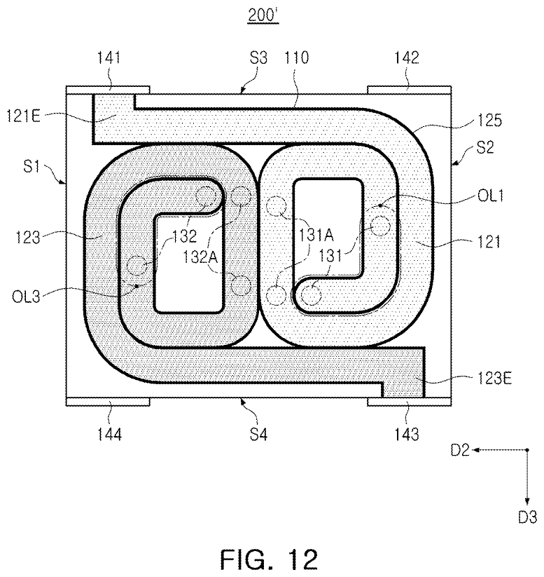

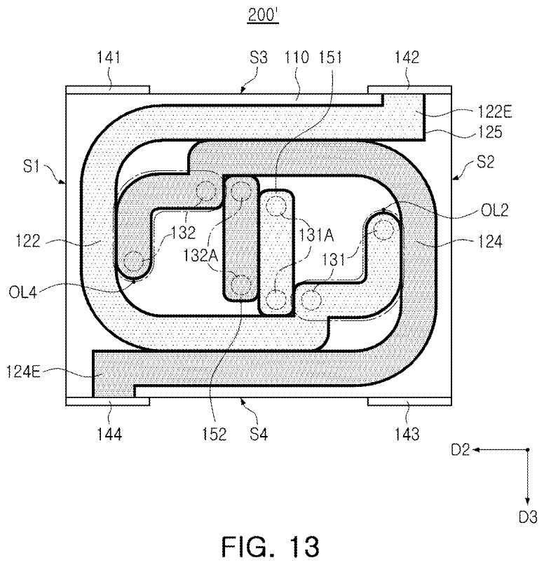

FIGS. 12 and 13, modifications of a coil component according to a second example embodiment, are top plan views of the coil component. FIGS. 12 and 13 respectively illustrate an upper coil and a lower coil with respect to a support member.

Referring to FIGS. 12 and 13, an arrangement of the first and second additional patterns 151 and 152 may vary depending on positions of the first and second additional vias 131A and 132A.

With respect to the other elements according to the present example embodiment, the description of the first example embodiment of the present disclosure may be applied in the same manner. The detailed description thereof is repeated, and thus omitted below.

### Third Example Embodiment

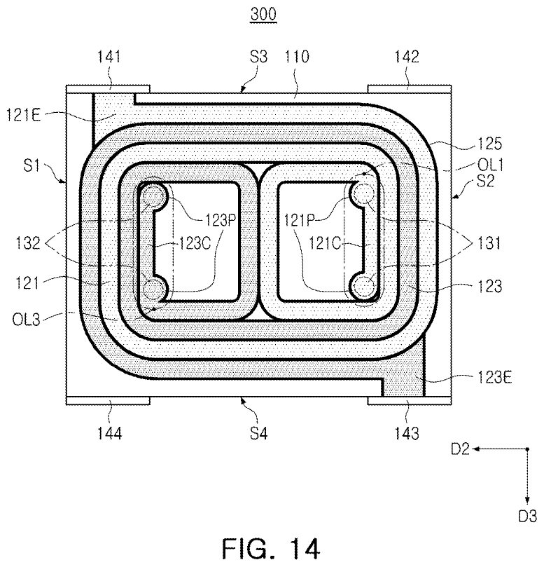

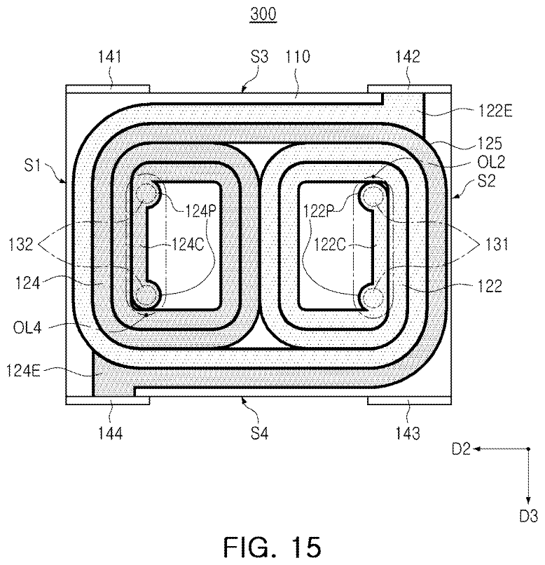

FIGS. 14 and 15 are top plan views of a coil component according to a third example embodiment, and respectively illustrate an upper coil and a lower coil with respect to a support member.

In a coil component 300 according to a third example embodiment, the number of turns of the coils 121, 122, 123, and 124 may be different from each other, as compared to that in the first example embodiment.

Specifically, each of the first to fourth coils 121, 122, 123, and 124 may have more than two turns.

As the number of turns of a coil increases, a degree of matching between upper and lower coils may decrease and asymmetry between the upper and lower coils may increase. Accordingly, the following modification presents a structure capable of further lowering DC resistance (R_{dc}) using a loss area of the core.

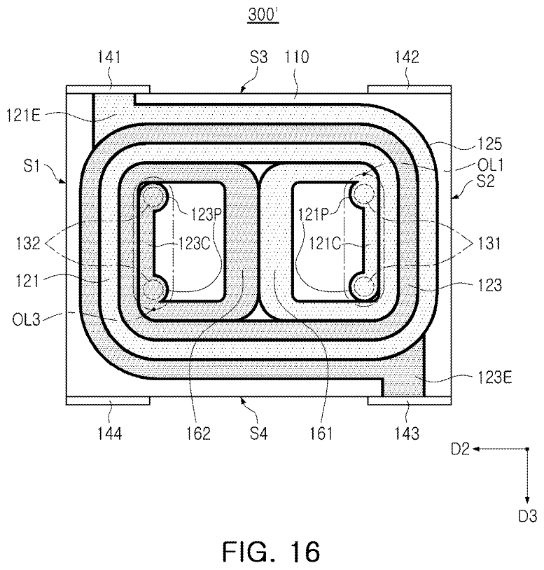

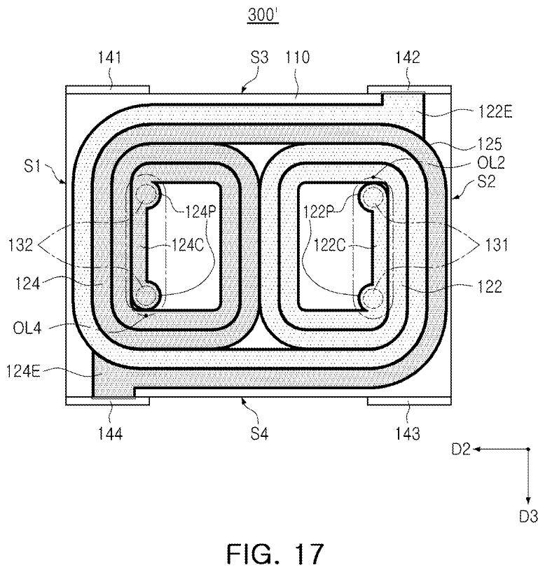

FIGS. 16 and 17, modifications of a coil component according to a third example embodiment, are top plan views of the coil component. FIGS. 16 and 17 respectively illustrate an upper coil and a lower coil with respect to a support member.

Referring to FIG. 16, a portion of an innermost turns of a first coil 121 may have a first line width increasing region 161 having a line width wider than that of an outer turn of the first coil 121. The first line width increasing region 161 may have a line width wider than that of an innermost turn of a second coil 122. That is, a portion of an upper coil 121 may have an increased coil line width to increase a degree of matching with a lower coil 122, and DC resistance (R_{dc}) may be further lowered using a loss area.

The first line width increasing region 161 may not be directly connected to a plurality of first conductive vias 131. The first line width increasing region 161 may oppose a first overlapping region OL1 in a second direction (direction D2).

Similarly, a portion of an innermost turn of the third coil 123 may have a second line width increasing region 162 having a line width wider than that of an outer turn of the third coil 123. The second line width increasing region 162 may have a line width wider than that of an innermost turn of the fourth coil 124. That is, a portion of an upper coil 123 may have an increased coil line width to increase a degree of matching with a lower coil 124, and DC resistance (R_{dc}) may be further lowered using a loss area.

The second line width increasing region 162 may not be directly connected to a plurality of second conductive vias 132. The second line width increasing region 162 may oppose a third overlapping region OL3 in the second direction (direction D2).

In the drawings, the coil component 300 is illustrated as having both the first line width increase region 161 and the second line width increase region 162, but the present disclosure is not necessarily limited thereto. In addition, in the drawings, the line width increasing regions 161 and 162 are formed in the upper coils 121 and 123 of the coil component 300, but the present disclosure is not necessarily limited thereto. For example, when a core area loss occurs in the lower coils 122 and 124, the line width increasing regions 161 and 162 may be formed in the lower coils 122 and 124.

With respect to a method of measuring a line width of a line width increasing region and an outer turn of a coil, a method of measuring a line width of a connection portion described in the first example embodiment may be applied by analogy. The detailed description thereof is repeated, and thus omitted below.

With respect to the other elements according to the present example embodiment, the description of the first example embodiment of the present disclosure may be applied in the same manner. The detailed description thereof is repeated, and thus omitted below.

While example embodiments have been shown and described above, it will be apparent to those skilled in the art that modifications and variations could be made without departing from the scope of the present disclosure as defined by the appended claims.

What is claimed is:

1. A coil component comprising:
a body;
a first coil and a second coil disposed within the body to be spaced apart from each other in a first direction;
a plurality of first conductive vias connecting the first and second coils to each other;
a third coil and a fourth coil disposed within the body to be spaced apart from each other in the first direction;
a plurality of second conductive vias connecting the third and fourth coils to each other;
first and second external electrodes disposed on the body and respectively connected to the first and second coils; and
third and fourth external electrodes disposed on the body and respectively connected to the third and fourth coils.

2. The coil component of claim 1, wherein
the first coil includes a plurality of first pads connected to the plurality of first conductive vias and a first connection portion disposed between the plurality of first pads, the first connection portion having a line width narrower than that of the first pad, and
the second coil includes a plurality of second pads connected to the plurality of first conductive vias and a second connection portion disposed between the plurality of second pads, the second connection portion having a line width narrower than that of the second pad.

3. The coil component of claim 2, wherein the first connection portion and the second connection portion overlap each other in the first direction.

4. The coil component of claim 2, wherein
the third coil includes a plurality of third pads connected to the plurality of second conductive vias and a third connection portion disposed between the plurality of third pads, the third connection portion having a line width narrower than that of the third pad, and
the fourth coil includes a plurality of fourth pads connected to the plurality of second conductive vias and a fourth connection portion disposed between the plurality of fourth pads, the fourth connection portion having a line width narrower than that of the fourth pad.

5. The coil component of claim 4, wherein the third connection portion and the fourth connection portion overlap each other in the first direction.

6. The coil component of claim 1, wherein
the first coil and the third coil are spaced apart from each other in a second direction, different from the first direction, and
the second coil and the fourth coil are spaced apart from each other in the second direction.

7. The coil component of claim 6, wherein
the body has a second surface and a first surface opposing each other in the second direction, the second surface and the first surface respectively adjacent to the first coil and the second coil, and a third surface and a fourth surface opposing each other in a third direction, different from the second direction and the first direction,
one end of the first coil is connected to the first external electrode on the first surface or the third surface of the body, and
one end of the second coil is connected to the second external electrode on the second surface or the third surface of the body.

8. The coil component of claim 7, wherein
the one end of the first coil is connected to the first external electrode on the first surface and the third surface of the body, and
the one end of the second coil is connected to the second external electrode on the second surface and the third surface of the body.

9. The coil component of claim 7, wherein
one end of the third coil is connected to the third external electrode on the second surface or the fourth surface of the body, and
one end of the fourth coil is connected to the fourth external electrode on the first surface or the fourth surface of the body.

10. The coil component of claim 7, wherein
one end of the third coil is connected to the third external electrode on the second surface and the fourth surface of the body, and
one end of the fourth coil is connected to the fourth external electrode on the first surface and the fourth surface of the body.

11. The coil component of claim 1, wherein
at least one of the first to fourth coils has a side surface toward an innermost turn from an outer turn adjacent to the innermost turn,
the side surface has a concave portion, and
at least one of the first to fourth pads has at least a portion disposed in the concave portion.

12. The coil component of claim 1, wherein
a portion of the third coil is disposed between an outermost turn and an inner turn, adjacent to the outermost turn, of the first coil, and
a portion of the first coil is disposed between an outermost turn and an inner turn, adjacent to the outermost turn, of the third coil.

13. The coil component of claim 1, wherein
the first coil and the second coil have an asymmetrical structure with respect to the first direction, and
the third coil and the fourth coil have an asymmetrical structure with respect to the first direction.

14. The coil component of claim 13, wherein the first coil and the second coil have different numbers of turns.

15. The coil component of claim 14, wherein
the first coil has one or more turns, and
the second coil has less than one turn.

16. The coil component of claim 13, wherein the third coil and the fourth coil have different numbers of turns.

17. The coil component of claim 16, wherein
the third coil has one or more turns, and
the fourth coil has less than one turn.

18. The coil component of claim 1, wherein
each of the first coil and the second coil has more than one turn, and
each of the third coil and the fourth coil has more than one turn.

19. The coil component of claim 1, wherein
each of the first coil and the second coil has more than two turns, and
each of the third coil and the fourth coil has more than two turns.

20. The coil component of claim 1, further comprising:
a first additional pattern connected to the first coil by a first additional via.

21. The coil component of claim 20, wherein the first additional pattern is disposed on a level substantially the same as that of the second coil with respect to the first direction.

22. The coil component of claim 20, wherein the second coil has less than one turn.

23. The coil component of claim 20, further comprising:
a second additional pattern connected to the third coil by a second additional via.

24. The coil component of claim 23, wherein the second additional pattern is disposed on a level substantially the same as that of the fourth coil with respect to the first direction.

25. The coil component of claim 23, wherein the fourth coil has less than one turn.

26. The coil component of claim 1, wherein a portion of an innermost turn of the first coil has a first line width increasing region having a line width wider than that of an outer turn of the first coil.

27. The coil component of claim 26, wherein the first line width increasing region has a line width wider than that of an innermost turn of the second coil.

28. The coil component of claim 26, wherein the first line width increasing region is spaced apart from the plurality of first conductive vias.

29. The coil component of claim 26, wherein
the innermost turn of the first coil and an innermost turn of the second coil respectively have a first overlapping region and a second overlapping region overlapping each other in the first direction, and
the first overlapping region and the first line width increasing region oppose each other in a second direction, different from the first direction.

30. The coil component of claim 26, wherein a portion of an innermost turn of the third coil has a second line width increasing region having a line width wider than that of an outer turn of the third coil.

31. The coil component of claim 30, wherein the second line width increasing region has a line width wider than that of an innermost turn of the fourth coil.

32. The coil component of claim 30, wherein the second line width increasing region is spaced apart from the plurality of second conductive vias.

33. The coil component of claim 30, wherein
the innermost turn of the third coil and an innermost turn of the fourth coil respectively have a third overlapping region and a fourth overlapping region overlapping each other in the first direction, and
the third overlapping region and the second line width increasing region oppose each other in a second direction, different from the first direction.

34. A coil component comprising:
a body;
a first coil and a second coil disposed within the body to be spaced apart from each other in a first direction;
a first conductive via connecting the first and second coils to each other;
a third coil and a fourth coil disposed within the body to be spaced apart from each other in the first direction;
a second conductive via connecting the third and fourth coils to each other;
first and second external electrodes disposed on the body and respectively connected to the first and second coils; and
third and fourth external electrodes disposed on the body and respectively connected to the third and fourth coils,
wherein an innermost turn of the first coil and an innermost turn of the second coil respectively have a first overlapping region and a second overlapping region overlapping each other in the first direction, and
each of the first overlapping region and the second overlapping region has a quarter turn more.

35. The coil component of claim 34, wherein
an innermost turn of the third coil and an innermost turn of the fourth coil respectively have a third overlapping region and a fourth overlapping region overlapping each other in the first direction, and
each of the third overlapping region and the fourth overlapping region has a quarter turn or more.

36. A coil component comprising:
a body;
a first coil and a second coil disposed within the body to be spaced apart from each other in a first direction;
a first conductive via connecting the first and second coils to each other;
a third coil and a fourth coil disposed within the body to be spaced apart from each other in the first direction;
a second conductive via connecting the third and fourth coils to each other;
first and second external electrodes disposed on the body and respectively connected to the first and second coils; and
third and fourth external electrodes disposed on the body and respectively connected to the third and fourth coils,
wherein a portion of an innermost turn of the first coil has a first line width increasing region having a line width wider than that of an outer turn of the first coil.

37. The coil component of claim 36, wherein a portion of an innermost turn of the third coil has a second line width increasing region having a line width wider than that of an outer turn of the third coil.

38. A coil component comprising:
a body;
a first coil and a second coil disposed within the body to be spaced apart from each other in a first direction;
a first conductive via connecting the first and second coils to each other;
a third coil and a fourth coil disposed within the body to be spaced apart from each other in the first direction;
a second conductive via connecting the third and fourth coils to each other;
a first additional pattern connected to the first coil by a first additional via;
first and second external electrodes disposed on the body and respectively connected to the first and second coils; and
third and fourth external electrodes disposed on the body and respectively connected to the third and fourth coils.

39. The coil component of claim 38, wherein the first additional pattern is disposed on a level substantially the same as that of the second coil with respect to the first direction.

40. The coil component of claim 38, wherein the second coil has less than one turn.

41. The coil component of claim 38, further comprising:
a second additional pattern connected to the third coil by a second additional via.

42. The coil component of claim 41, wherein the second additional pattern is disposed on a level substantially the same as that of the fourth coil with respect to the first direction.

43. The coil component of claim 41, wherein the fourth coil has less than one turn.

44. A coil component comprising:
a body;
a support member disposed in the body;
a first coil and a second coil disposed on opposing surfaces of the support member and in the body;
a plurality of conductive vias penetrating through the support member to connect the first and second coils to each other; and
first and second external electrodes disposed on the body and respectively connected to the first and second coils.

45. The coil component of claim 44, wherein
the first coil includes a plurality of first pads connected to the plurality of conductive vias and a first connection portion disposed between the plurality of first pads, the first connection portion having a line width narrower than that of the plurality of first pads, and
the second coil includes a plurality of second pads connected to the plurality of conductive vias and a second connection portion disposed between the plurality of second pads, the second connection portion having a line width narrower than that of the plurality of second pads.

46. The coil component of claim 45, wherein the first connection portion and the second connection portion overlap each other in a stacking direction of the first and second coils.

47. The coil component of claim 45, wherein a region where the plurality of first pads and the first connection portion are disposed has a quarter turn or more.

48. The coil component of claim 44, wherein
at least one of the first and second coils has a side surface toward an innermost turn from an outer turn adjacent to the innermost turn,
the side surface has a concave portion, and
at least one of the first and second pads has at least a portion disposed in the concave portion.

49. The coil component of claim 44, wherein a portion of an innermost turn of the first coil has a first line width increasing region having a line width wider than that of an outer turn of the first coil.

50. The coil component of claim 49, wherein the first line width increasing region is spaced apart from the plurality of first conductive vias.
